(19) United States
(12) Patent Application Publication
(10) Pub. No.: US 2008/0270080 A1
(43) Pub. Date: Oct. 30, 2008

(54) Hierarchical Real-Time Patient State Indices for Patient Monitoring

(75) Inventor: Wei Zong, Croton-On-Hudson, NY (US)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/097,278

(22) PCT Filed: Dec. 14, 2006
(86) PCT No.: PCT/IB06/54868

§ 371 Date: Jun. 13, 2008

Related U.S. Application Data
(60) Provisional application No. 60/751,535, filed on Dec. 19, 2005.

(51) Int. Cl. G06F 11/00

(52) U.S. Cl. 702/188

(57) ABSTRACT

A medical patient is monitored, and simultaneous patient state indices (416) based on function of respective organs and/or presence of respective disease in the monitored patient, i.e., the respective patient sub-area, are updated in real time. The indices are displayed, alongside actual past and predictive trend data for the index (320, 328). The screen hierarchy provides immediate access, from a screen showing an overall index and a summary of patient sub-areas, to a screen (500) offering more detail on the selected sub-area. Further immediate traversal is available to the raw measurements (420-432) supportively underlying the derived indices.

The present invention relates to monitoring the well-being of a medical patient and, more particularly, to utilizing patient state indices that respectively apply to different organs or diseases of the monitored patient.

Modern intensive care units (ICUs) employ an impressive array of sophisticated instrumentation to provide detailed measurements of the pathophysiologic state of each patient. Those measurements include real-time physiological signals such as electrocardiogram (ECG), arterial blood pressure (ABP), and central venous pressure (CVP), arrhythmia analysis results and vital signs derived from the related signals, mechanical ventilation parameters, intra-venous (IV) pump readings, medications, fluid balances, and a wide variety of laboratory results. The measurements likewise include blood gas and biochemistry examinations, clinical observations and imaging studies.

Although the availability of relevant data has been increasing, the organization of the enormous amount of data is poor. The measurements and single-variable limit alarms are separately provided to clinicians, leaving the data integration and interpretation mainly to the clinicians. Simply presenting the physiological data en masse to the ICU staff does not yield significant clinical benefit. ICU clinicians consequently face “information overload.” This may actually hinder the diagnostic process, and may even lead to neglect of relevant data, resulting in errors and complications in patient care. There exists a need for a system that can not only help display, organize and integrate the relevant data correctly, but also support the clinical interpretation of data.

To estimate patient general condition or status, there are methods for calculating a mortality index based on a snapshot of the patient's physiology at the time of admission. Some of the methods assign a predetermined number of points to certain medical observations, measurements, medical data and the like. These acuity scores reflect the patient's condition, i.e., the probability of mortality, but are inadequate predictors or indicators of patient's continuous and detailed condition. They are accordingly not suitable for ICU patient monitoring.

It would be advantageous, to meet the shortcomings of the prior art, to continuously track the overall and detailed pathophysiological state of the patient, timely indicate alarms or alerts in the case of critical events, and supply clues about what kind of critical events are happening, i.e., which parts of the patient are in trouble. A further desirable feature would be to indicate the possible causes of critical events, and provide the user with the ability to drill down in order to check the more detailed records on which the annotated summary is based.

The current methodology of mortality index is limited to providing partial information on the patient's condition in general. Detailed indications of the patient's condition, such as which areas of the patient are in trouble and what critical events are happening that need intervention, are not available.

As disclosed herein, the “information overload” problem can be overcome by effectively summarizing the massive amount of ICU data, tracking the detailed patient condition in terms of organ function and/or disease presence, and visualizing the detailed records on which the automated summary is based.

The present invention employs a “divide and conquer” technique to divide the human patient system into multiple sub-areas based on organ function and/or disease presence.

In particular, a medical patient is monitored, and simultaneous patient state indices based on function of respective organs and/or presence of respective disease in the monitored patient are updated in real time.

For each sub-area, analysis is made of those measurements that are relevant, responsible and contributing to the function of the sub-area, and the respective diagnosis. Based on the analysis, a corresponding sub-patient state index (PSI) is derived, in real time, for this sub-area. The sub-PSI value time series and all of the raw measurements that are used to support the sub-PSI are stored, and can be tracked and reviewed. On top of the sub-PSIs, an overall PSI is derived to indicate the overall situation concerning the patient's state or condition. The overall PSI is a summary of all of the sub-PSIs. Any noticeable problem in any of the sub-areas indicated by the sub-PSI is reflected in the overall PSI. Advantageously, the clinician can drill down selectively, from the overall PSI, to choose a sub-PSI and to associated measurement values or evidence. The clinician can therefore easily check the more detailed records on which the automated summary is based.

Details of the novel patient state indices are set forth below with the aid of the following drawings, wherein similar features are annotated with the same reference numerals throughout:

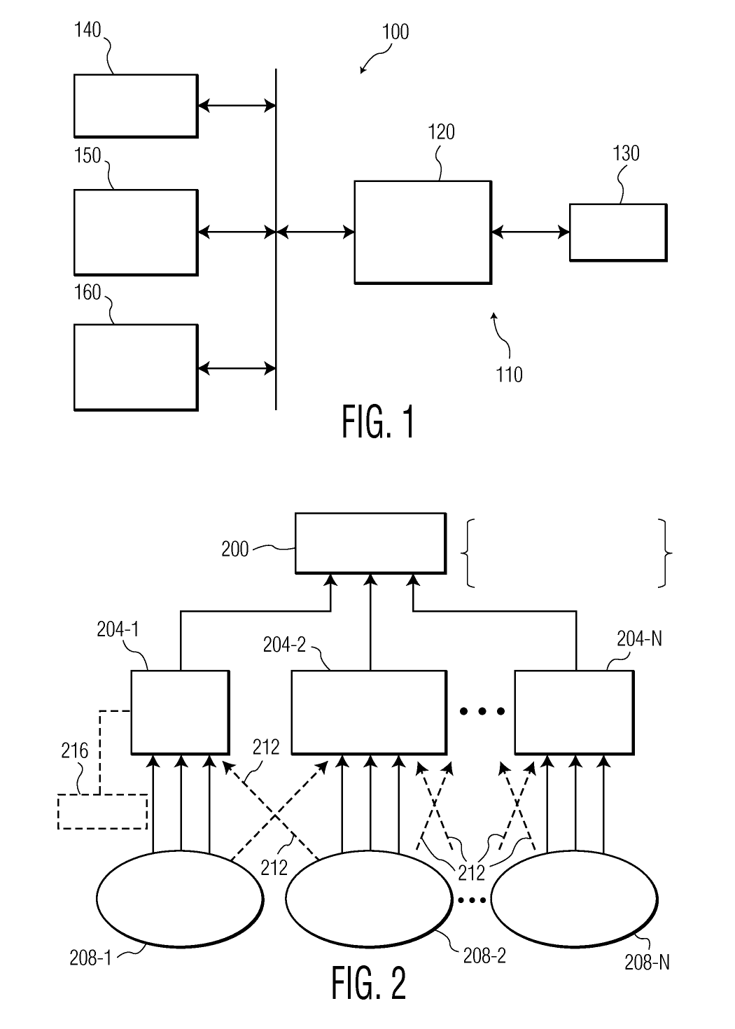

FIG. 1 is a diagram of a network that includes a hierarchical patient state indices (HPSI) system, in accordance with the present invention;

FIG. 2 is a conceptual diagram providing a functional overview of an HPSI processor in the HPSI system in FIG. 1;

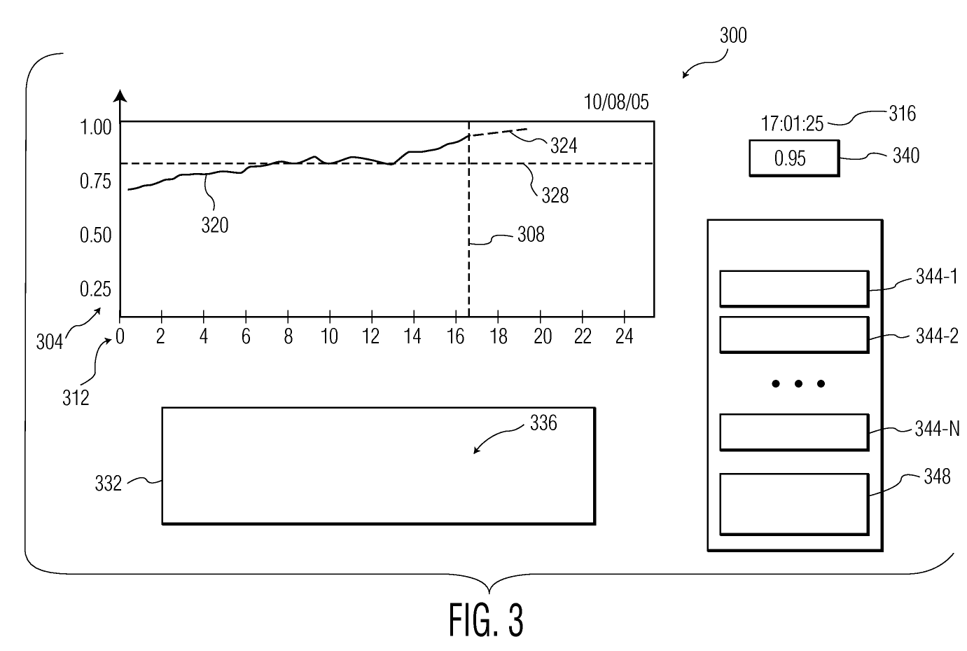

FIG. 3 is a format diagram of an exemplary home screen, according to the present invention;

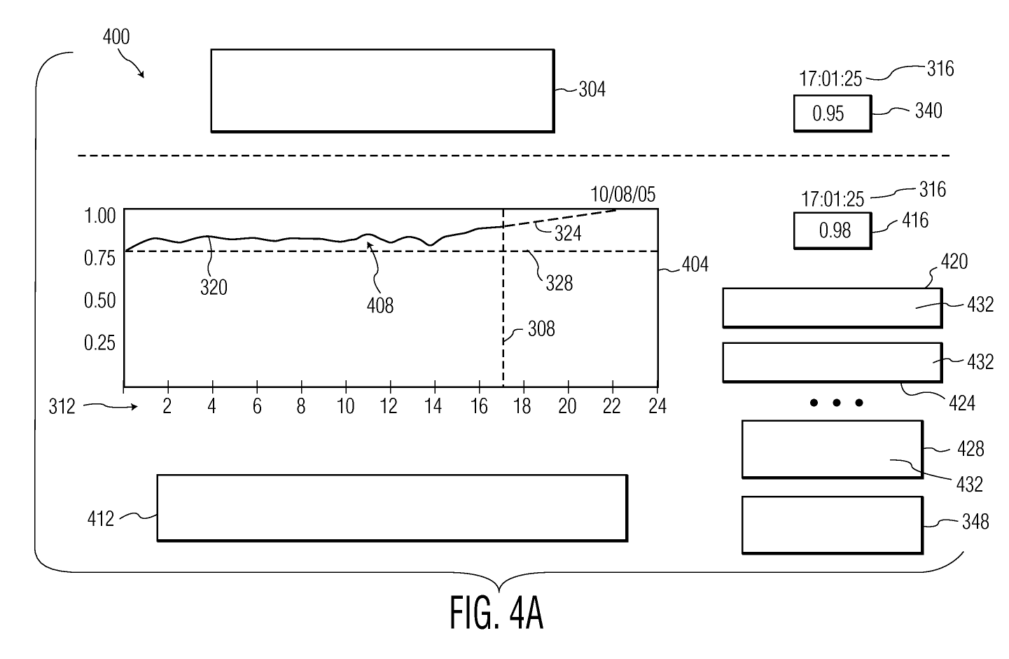

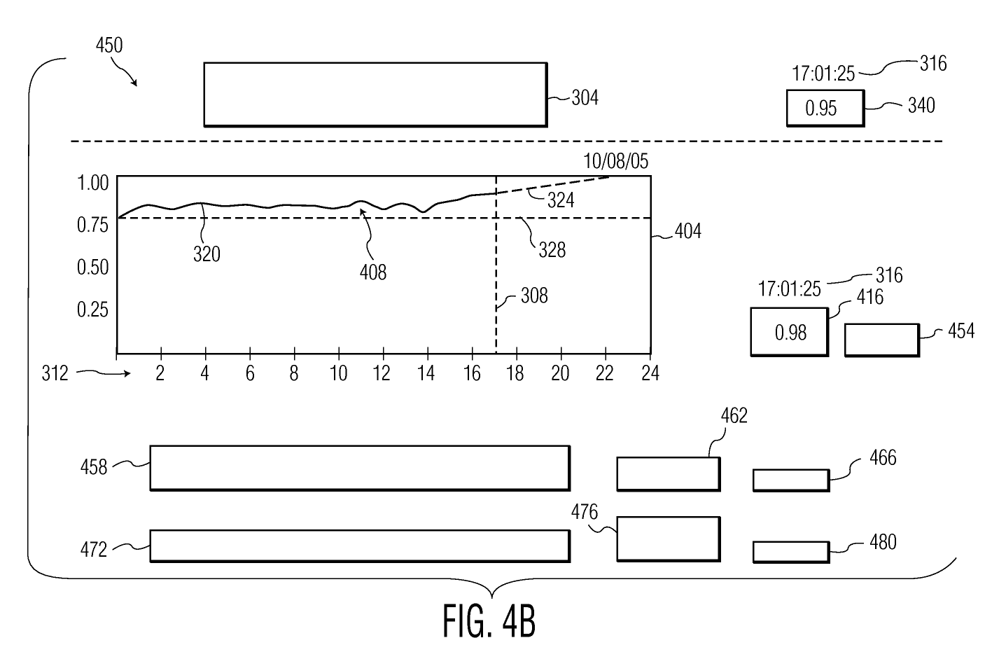

FIG. 4A is a format diagram of an exemplary sub-PSI screen, according to the present invention;

FIG. 4B is a format diagram of an exemplary screen for all sub-PSIs, according to the present invention;

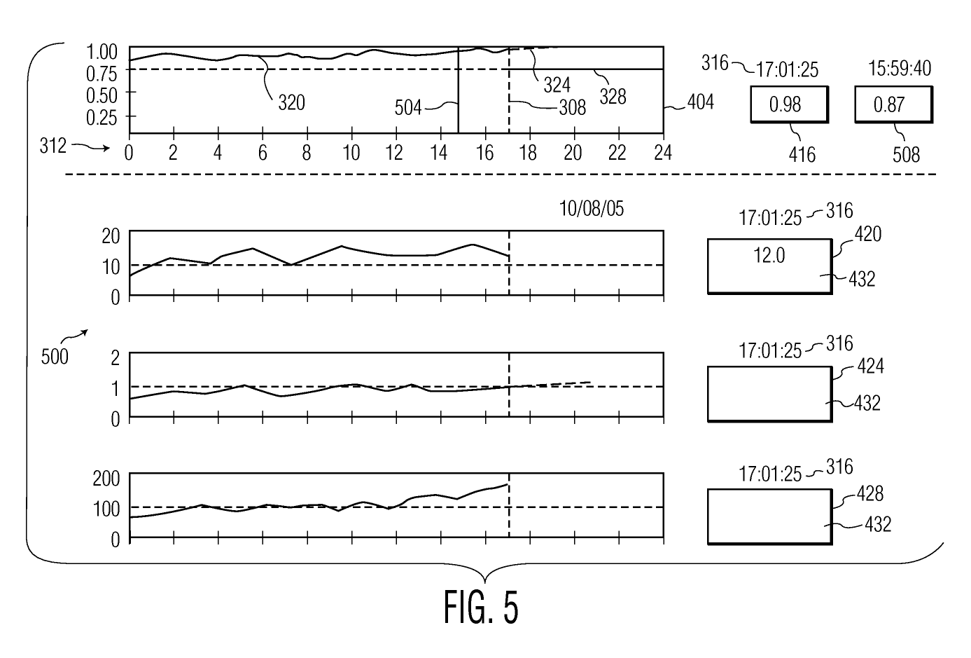

FIG. 5 is a format diagram of an exemplary evidence screen, according to the present invention;

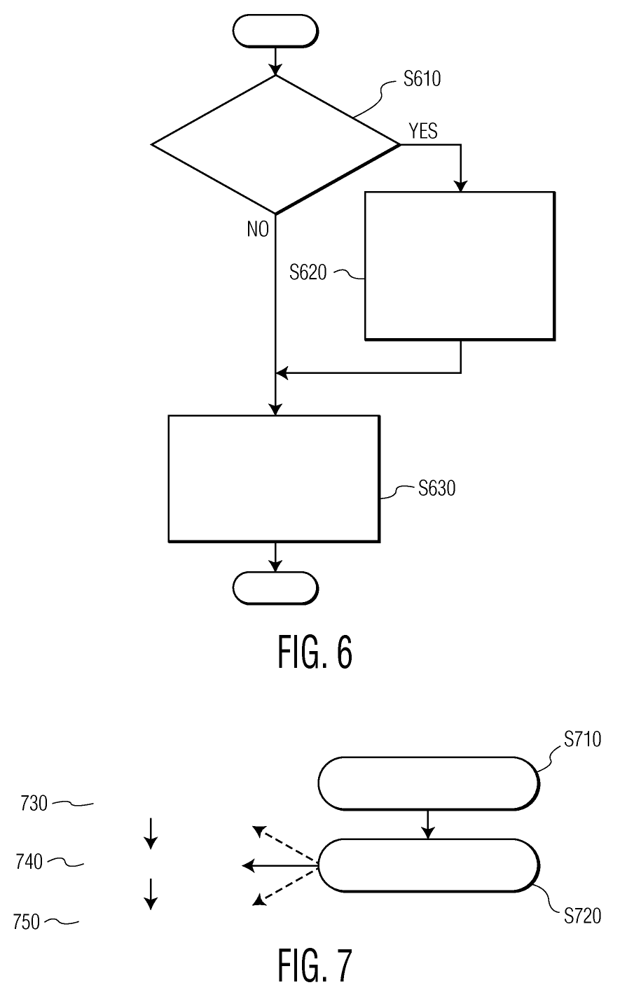

FIG. 6 is a flow chart of a vertical cursor shifting technique, according to the present invention; and

FIG. 7 is a conceptual diagram demonstrating event-driven traversal of screen hierarchy, according to the present invention.

FIG. 1 shows an example of a network 100, of a hospital, institution or other enterprise, which includes a hierarchical patient state indices (HPSI) system 110, in accordance with the present invention. The HPSI system includes an HPSI processor or inference engine 120 and a user interface 130. In communicative connection with the HPSI system 110, the hospital network 100 features bedside monitors 140, a clinical charting or clinical information system 150 and an electronic medical record (EMR) or hospital information system 160.

The HPSI processor 120 includes a receiver (not shown) by which to receive or retrieve ICU patient data in real time through the hospital network 100. The data arrives from multiple data sources such as the bedside monitors 140, the clinical charting system 150, e.g., the CareVue Chart™ by Philips, and the EMR 160. Analyzing algorithms in the processor 120 analyze these data into groups. Each group is devoted to a specific sub-area relating to an organ function or a disease presence. The algorithms then generate patient state indices (PSIs) for the various groups and a composite or overall PSI. The processor 120 also issues alarms or alerts, and makes a linguistic summarization of findings on the patient's condition. The overall PSI, sub-PSIs, their associated information, and the original measurement data are stored in a storage area (not shown) accessible to the processor 120. The storage area may include any variety of random access memory (RAM), and non-volatile memory such as any of the various read-only memories (ROM), flash memory, or media such as a hard disk, floppy disk or optical disc. The user interface 130 displays the PSI values and trends in these values, the associated information, and the raw measurements in a clinically useful manner. The user interface preferably includes a screen and may include other forms of output to the user, e.g. audio speakers. User input may occur on-screen in the case of a touch screen, and may entail use of a mouse, trackball, keyboard, slider, video camera, microphone and/or any other known and suitable means.

FIG. 2 provides an example of how the HPSI processor 120 is structured, according to the present invention. An overall PSI 200 is derived from multiple PSIs or “sub-PSIs” 204-1, 204-2, 204-N, to represent the patient's state of well-being overall, the dots shown between the sub-PSIs 204-2, 204-N indicating that any number of sub-PSIs 204 of respective sub-areas may be utilized. The overall PSI 200 can have a value between 0 and 1, or between 0 and 100, for example, with 0 representing the worse situation and the other range limit representing the best. Its value is preferably updated or reassessed whenever any sub-PSI 204 changes in value. The overall PSI 200 is displayed instantaneously and its history or trend can be tracked for recording and display. The overall PSI 200 summarizes the sub-PSIs 204 such that any problems noticeable from any of the sub-PSIs are reflected in the overall PSI. It may be formulated as the minimum over, or a sum or a weighting of, the members of a set consisting of the sub-PSIs 204. Any appropriate weighting mechanism can be considered, including the weighting of powers of the sub-PSIs 204. Nor are the possible calculation techniques limited to these examples.

The sub-PSIs 204 shown in FIG. 2 are classified according to organ function, with sub-PSI 204-1, 204-2, 204-N applying to renal, cardiovascular and respiratory function, respectively. Another example of organ function is neural. The sub-PSIs 204 can also be classified according to disease presence, or a mixture of the two classifications can be made. Disease presence classifications would be applicable to those cases involving high mortality risks such as sepsis, hemorrhage shock, and multi-organ failure. The processor 120 is configured to define, or to be operable to define, the actual sub-PSIs used by considering the availability of data and areas of focus.

A specific set of measurements or parameters 208-1, 208-2, 208-N is associated with each respective sub-PSI 204-1, 204-1, 204-N in that the set 208 contributes to the diagnosis of the corresponding sub-area of the patient. The dashed arrows 212 reflect the possibility, and likelihood, that at least some of the parameters in the sets 208 are responsible for multiple PSIs 204. The sub-PSIs 204 are updated in real time from clinical data incoming from the hospital network 100, and are displayable in real time alongside their trends. The incoming clinical data or raw measurements serve as evidence that underlay or support the calculated sub-PSIs 204, and are likewise displayable in real time.

The analyzing algorithms use techniques such as trend feature analysis, i.e., the analysis of features in the (sub-)PSI trend curves, pattern recognition and data mining to derive the index in real time. In each sub-area, existing medical knowledge for diagnosis, i.e., estimation and/or prediction, of the patient's state is utilized. New knowledge can be gleaned, in preparation or in real time, by investigating the relevant massive data in available ICU databases such as the Multi-Parameter Intelligent Monitoring for Intensive Care (MIMIC) database. Performance evaluation of the algorithms can involve using the MIMIC database to assess the estimation or prediction of the patient's state overall and in sub-areas. Clinical trials can be used alternatively or in addition.

Sufficient complexity in a sub-area may warrant creation of component sub-sub-areas 216. The processor 120 may form the sub-area in real-time. PSI and trend data for the sub-sub-area 216 might involve an additional screen in the hierarchy, and yet another screen for respective evidence.

The “divide and conquer” strategy allocates the enormous number of measurements among respective sub-areas, which greatly simplifies the task of deriving a PSI, i.e., piecemeal by sub-area. Also, the sensitivity and specificity of each individual sub-PSI is enhanced. Another advantage is that the each sub-PSI can be investigated and evaluated individually. Yet another advantage is that the system is extendible, in real time: when one sub-PSI is developed, it is then included; if new data becomes available and a new sub-area comes into consideration, a new sub-PSI can be included.

Appropriate thresholds can be applied to the PSIs, and to the sub-PSIs, for alarming and/or alerting purposes.

Linguistic or human language summaries about the patient state overall and in each sub-area can be derived based on pathophysiologic reasoning from the patient's condition and the measurements evidence.

The processor 120 can, in addition, generate predicted values of the near future for a sub-PSI, as well as the overall PSI, based on the patient's existing condition and the trend in the index.

Screens rendered by means of the user interface 130, in conjunction with or operable under control of the processor 120, are organized in a hierarchy. Thus, navigating from one screen to another may require navigation to an intervening screen in the hierarchy. Through the screen hierarchy, information is rendered in a layered manner. There are three major layers: 1) the home screen, showing the overall PSI value over time, overall summary of the patient's condition, and links to the sub-PSIs; 2) the sub-PSI screen, showing each specific sub-PSI value over time, summary of the patient's condition in the sub-area, and links to the supporting measurement facts; and 3) the evidence screen, showing the measurement values over time for each sub-area. Traversal of the hierarchy occurs by action of a user over the user interface 130 and/or by an event-driven display mechanism that automatically determines the appropriate screen to display according to the patient's condition.

FIG. 3 depicts, by way of illustrative and non-limitative example, a home screen 300 in accordance with the present invention. The home screen 300 includes a graphic window 304 showing the overall PSI 200 over time. A vertical cursor 308 tracks, in real time, the current time against a time scale 312. The time scale may be fixed, so that the number zero corresponds to noon, or to midnight, and the number two corresponds to 2:00 A.M. or P.M., respectively, for example. The current time is correspondingly displayed in digital form in a screen field 316. A solid curve 320, in the context of the time scale 312, precedes the vertical cursor 308, and represents the actual, overall PSI 200 over time. By contrast, the dashed curve 324 “temporally” following the vertical cursor 308 represents a prediction of the PSI value over time, for the near future. Thus the two curves 320, 324 are joined at the intervening vertical cursor 308. The time scale 312 is user-controllable in terms of zooming in and out, and scrolling backward and forward. The time scale 312, under user control, may also be scaled linearly and logarithmically. It may also, instead of representing fixed time, represent relative time, as in 2 hours since a particular event, 4 hours since a particular event, etc.

An alarm or alert message issues whenever the overall PSI 200 drops below an adjustable threshold 328 displayed as a horizontal line in the graphic window 304. Below the graphic window 304, a text box 332 provides machine-generated description of the patient's condition, including the summary of findings 336, alarm/alert messages, etc. The summary of findings 336 is a summary of the patient's overall condition in plain language that preferably is understandable to a layman with respect to the medical profession.

An overall PSI value 340 at the vertical cursor 308 time point, i.e., the current overall PSI value, is displayed on the right side of the screen along with all of the current sub-PSI values 344-1, 344-2, 344-N that support the current overall PSI 340. By clicking on, or otherwise selecting, any of the sub-PSIs 344, e.g., the renal sub-PSI 344-1, the corresponding sub-PSI's detailed information appears on-screen. The format of the detailed information appears below in FIG. 4A, in a screen which is immediately next, i.e., one level down, in the screen hierarchy.

The vertical cursor 308 progresses automatically in the graphic window 304 with time. However, the user may also move the vertical cursor 308, as when switching from fixed time to relative time. Even if fixed time is used exclusively, a second vertical cursor may be elicited, as by dragging it from the first cursor 308, while leaving the first cursor in place, to display corresponding digital readings in an additional screen field, as discussed further below in connection with FIG. 5.

A box or button 348 is selectable for viewing all sub-PSIs and accompanying data simultaneously on-screen, while maintaining the overall PSI information on the top of the screen as a reference. This screen format appears below in FIG. 4B.

FIG. 4A exemplifies a sub-PSI screen 400, according to the present invention, and is pictured in FIG. 4A to correspond to the image that might appear upon clicking on the renal sub-PSI field 344-1 shown in FIG. 3. As a reference, the graphic window 304 is maintained, preferably in smaller size, at the top of the sub-PSI screen. Below this, a sub-PSI graphic window 404 appears. Its design is analogous to that of the graphic window 304 in FIG. 3, but adapted for displaying the sub-PSI 408 over time, rather than the overall PSI 200. Likewise, machine-generated description 412 of the patient's condition relates to the current sub-PSI 416 for renal function. Current measurements for blood urea nitrogen (BUN) 420, creatinine 424 and sodium 428 appear on-screen. As an example, the concentration measurements 420, 424, 428 are accompanied by a slope parameter 432 indicative of average slope in the near past. The third measurement 428 relates to sodium concentration, i.e., 140 milliequivalents per liter.

In FIG. 4B, an all sub-PSIs screen 450 displays all sub-PSIs and accompanying data simultaneously on-screen, while maintaining the overall PSI information 304, 316, 340 on the top of the screen as a reference. Next to the sub-PSI graphic window 404 for the renal function appears the current sub-PSI 416, just as in FIG. 4A. A detail box 454 is user-selectable to bring up the respective sub-PSI screen 400, and, thus, the additional detail 420-432 and findings summary 412 for the selected sub-area. This represents another route through the screen hierarchy for reaching the sub-PSI screen 400, as an alternative to clicking on the field 344-1, . . . 344-N in FIG. 3. In effect, by selecting or clicking on the index 416, detail 412, 420-432 relating specifically to the index and to its value, here “0.98,” is brought up immediately responsive to the selection. The detail 412, 420-432 is brought up on a screen 400 on the immediately next level down in the screen hierarchy. The all sub-PSIs screen 450 likewise entails the analogous on-screen structures 458-480 for the cardiovascular and respiratory sub-areas, and the same navigation functionality responsive to selecting the details box 466, 480. Any number of sub-areas of the patient may be represented.

FIG. 5 illustrates an exemplary evidence screen 500, according to the present invention, providing both actual values and trends of the related measurements from which the sub-PSI was derived. As a reference, the top of the screen shows, again somewhat minimized, the sub-PSI graphic window 404 from the immediately-above level in the screen hierarchy, i.e., the sub-PSI screen for renal function whose box 344-1 was selected. For illustrative purposes, however, the window 404 here in FIG. 5 includes a second vertical cursor 504 and is correspondingly accompanied by the appearance of a previous sub-PSI field 508. These additional screen features allow the user to digitally specify any displayed point in the actual, previous data or, although not specifically discussed herein, in the displayed predictive trend data. The renal sub-PSI reading in the field 508 was taken at the time 512 indicated by the second vertical cursor 504. The latter was elicited from the first vertical cursor 308, as by dragging it using a mouse, while the first vertical cursor remained in place to maintain its position indicating the current time. Upon eliciting the second vertical cursor 504, the first vertical cursor may start to flash, so as to distinguish the two cursors. Alternatively, different colors, translucency and/or thickness may be utilized on-screen, or any other known and suitable technique may be employed. If the second vertical cursor 504 is dragged back to meet the first vertical cursor 308, the second vertical cursor disappears, along with accompanying fields 508, 512. The dragging operation can shift merely the vertical cursor dragged, or, according to user selection, cause second vertical cursors to be correspondingly dragged in unison in each window of the screen. The vertical cursor thereby elicited are accompanied by respective digital readings and timestamps positioned analogously to the fields 508, 512. Likewise, if, by user selection, the first vertical cursor is dragged merely to, for example, shift between fixed and relative time scales 312, the user can select whether the dragging pertains to the individual window or to all of the currently displayed windows.

Below the top panel 404, the evidence screen 500 displays all of the measurement values over the same time period indicated by the time scale 312. In addition, on the right, the measurement field 420, 424, 428, 432 are shown and are identical to those shown in FIG. 4.

To the right of the top panel 404, the sub-PSI reading 416 for renal function is retained from the immediately above screen 450 in the screen hierarchy. While in the present evidence screen 500, the user is immediately alerted in the event the overall PSI, or any sub-PSI, drops below its respective threshold 328. Thus, the user can navigate up to the immediately above level, i.e., the sub-PSI screen 400, or two levels up to the overall PSI screen 300, or, in a preferred embodiment, can click on a flashing on-screen alert message to be taken immediately to the overall PSI screen 300. Preferably, all (sub-)PSIs exceeding their threshold are flashing, highlighted or otherwise emphasized.

FIG. 6 provides an example of a vertical cursor shifting technique, according to the present invention. A decision is made as to whether vertical cursors are to be shifted in unison (step S610). The logic in FIG. 6 may apply to either the first vertical cursor 308 or to the second vertical cursor 504, or to both cursors. The decision whether to shift in unison may be, by default, to shift individually for example, or may require user input on the user interface 130 to decide between the two courses (step S620). The user then shifts the selected vertical cursor by means of the user interface 130 (step S630).

FIG. 7 pictorially demonstrates event-driven traversal of screen hierarchy, according to the present invention.

On the one hand, in a preferred embodiment of the processor 120, the home screen 300 is the default screen in the hierarchy. If any sub-area experiences trouble, this is detectable on the home screen, and the user can navigate immediately down to that sub-area, and again immediately down to the measurements if needed.

However, in another preferred embodiment, the processor 120 is event-driven to traverse the screen hierarchy to the currently appropriate screen, subject to user override. This mode of operation can preferably be turned on or off by the user. In event-driven mode, the home screen is automatically shown as long as the patient's condition is sufficiently good. In particular, the processor 120 checks the patient's current condition (step S710). If a critical event is detected, the processor makes an event-driven selection (step S720) to navigate down one level from the home screen 730 to the sub-PSI screen 740 pertaining to the troubled sub-area. Illustratively, FIG. 7 shows this situation, the solid arrow pointing to the current screen 740, and the arrows having broken lines representing other levels in the screen hierarchy. Concurrently, the processor 120 issues an alarm or alert message to the user. If the trend data of a particular measurement to which the particular sub-PSI is responsive is judged, by the processor 120, to be especially important, the processor may automatically go down another level to the evidence screen 750.

If there are multiple, concurrent patient-condition events, e.g., acute renal failure, pulmonary edema, and sepsis, the processor 120 ranks them by severity based on sub-PSI value 204. The events are then queued, with the most serious one on top. The display of the user interface 130 is switched to the sub-PSI screen corresponding to the top entry on the queue. The switched-to screen features a vertical bar list of the extra critical events in the remainder of the queue. The bar list is ordered, by number or color for example, according to severity of the event, and is accompanied by links to the corresponding sub-PSI screens.

While there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, the HPSI system 110 may be integrated into the charting system 150. It should be recognized that structures and/or elements and/or method steps shown and/or described in connection with any disclosed form or embodiment of the invention may be incorporated in any other disclosed or described or suggested form or embodiment as a general matter of design choice.

1. A computer implemented method for tracking patient well-being comprising:
monitoring a medical patient; and
updating, in real time, a plurality of simultaneous patient state indices based on at least one of function of respective organs, and presence of respective disease, in the monitored patient.

2. The method of claim 1, further comprising:
presenting on-screen an index of the plural indices, the presented index having a value;
selecting, by a user, the presented index; and
presenting on-screen, immediately responsive to said selecting, detail relating specifically to said presented index and said value.

3. The method of claim 1, further comprising:
computing, from the plural indices, an overall index; and
presenting, to a user of said method, said plural indices and, simultaneously, said overall index.

4. The method of claim 3, wherein said presenting occurs on a home screen at a top level of a screen hierarchy, said method further comprising:
showing a selected one of said plural indices over time in an immediately next level down in said hierarchy; and
showing a plurality of measurement values over time for said selected one of said plural indices in a next level of said hierarchy immediately down from the level in which said selected one is shown.

5. The method of claim 3, wherein the computing is such that said overall index is responsive to each of said plural indices.

6. The method of claim 5, wherein said computing is such that said overall index is a minimum over, or a sum or weighting of, the members of a set consisting of all of said plural indices.

7. The method of claim 1, further comprising at least one of presenting an index of the plural indices at one level of a hierarchy and presenting, at another level of said hierarchy, an overall index based on said plural indices, said hierarchy being traversable, automatically and without user intervention, by event-driven selection performed by a processor based on patient current condition corresponding respectively to said plural indices updated in real time.

8. The method of claim 1, further comprising:
making, by a processor, a summary of an overall condition of said medical patient in plain language understandable to a layman with respect to the medical professions; and
presenting, by the processor, the made summary.

9. The method of claim 1, further comprising:
presenting, by a processor, a curve representing, over time, an index of the plural indices;
joining, to said curve, another curve representing prediction of said index over future time, a vertical cursor intervening between the two curves; and
progressing, by said processor, said cursor in real time, automatically and without user intervention.

10. A computer software product for tracking patient well-being, said product having a computer readable medium in which is embedded a program comprising instructions executable by a processor to perform acts comprising said monitoring and said updating of claim 1.

11. An apparatus for tracking patient well-being, comprising:
a receiver for receiving data pertaining to a particular medical patient who is being monitored; and
a processor configured for updating, in real time, a plurality of simultaneous patient state indices based on at least one of function of respective organs, and presence of respective disease, in the monitored patient.

12. The apparatus of claim 11, further comprising a user interface operable, in conjunction with said processor, to present on-screen an index of the plural indices, the presented index having a value, and to present on-screen, immediately responsive to selection of the presented index by a user, detail relating specifically to said presented index and said value.

13. The apparatus of claim 11, further comprising a user interface operable, in conjunction with said processor, to present, to a user, the plural indices and, simultaneously, an overall index computed from said plural indices.

14. The apparatus of claim 13, wherein the presenting occurs on a home screen at a top level of a screen hierarchy, said user interface being further operable, in conjunction with said processor, to show a selected one of said plural indices over time in an immediately next level down in said hierarchy and to show a plurality of measurement values over time for said selected one of said plural indices in a next level of said hierarchy immediately down from the level in which said selected one is shown.

15. The apparatus of claim 13, wherein the computing is such that said overall index is responsive to each of said plural indices.

16. The apparatus of claim 15, wherein said computing is such that said overall index is a minimum over, or a sum or weighting of, the members of a set consisting of all of said plural indices.

17. The apparatus of claim 11, further comprising a user interface operable, in conjunction with said processor, to perform at least one of presenting an index of the plural indices at one level of a hierarchy and presenting, at another level of said hierarchy, an index which is an overall index based on said plural indices, said hierarchy being traversable, automatically and without user intervention, by event-driven selection performed by said processor based on patient current condition corresponding respectively to said plural indices updated in real time.

18. The apparatus of claim 11, further comprising a user interface operable, in conjunction with said processor, to present, a summary of an overall condition of said medical patient in plain language understandable to a layman with respect to the medical profession.

19. The apparatus of claim 11, further comprising a user interface operable, in conjunction with said processor, to:
present a curve representing, over time, an index of the plural indices;
join, to said curve, another curve representing prediction of said index over future time, a vertical cursor intervening between the two curves; and
progress said vertical cursor in real time, automatically and without user intervention.

20. The apparatus of claim 19, wherein said processor is further configured to, under user control, elicit, from said vertical cursor, a second vertical cursor, and to selectively shift said second vertical cursor individually or in unison with another vertical cursor on said screen.

21. A system for monitoring patient well-being, comprising the apparatus of claim 11, said system further comprising:
a user interface operable in conjunction with said processor; and,
in real time communicative connection with said processor, a patient monitor, an electronic medical record and a clinical charting system.
